(19) United States
(12) Patent Application Publication
(10) Pub. No.: US 2026/0178844 A1
(43) Pub. Date: Jun. 25, 2026

(54) TRANSFORMING SEMANTICALLY EQUIVALENT DATA USING LARGE LANGUAGE MODELS

(71) Applicant: International Business Machines Corporation, Armonk, NY (US)

(72) Inventors: Nitin Gupta, Saharanpur (IN); Shramona Chakraborty, Howrah (IN); Hima Patel, Bengaluru (IN); Sameep Mehta, Bangalore (IN)

(21) Appl. No.: 19/000,810

(22) Filed: Dec. 24, 2024

(51) Int. Cl. G06F 40/40

(52) U.S. Cl. CPC G06F 40/40

(57) ABSTRACT

A computer-implemented method for transforming data is provided. A processor set receives a number of data pairs. The processor set creates a program graph for each data pair in the number of data pairs. The processor set identifies a number of paths between nodes in each program graph. The processor set identifies a number of common paths from the number of paths based on common characters between the input data and the output data for each data pair. The processor set identifies a set of nodes in the program graphs based on the number of common paths. The processor set generates a prompt for a large language model based on the number of data pairs and the set of nodes that represent positions of unmatched characters between input data and output data in the number of data pairs.

### BACKGROUND

The disclosure relates generally to transforming data using a large language model.

A large language model is a type of deep learning model designed to understand and process human language. Large language models are trained on massive amounts of text data from diverse data sources to learn patterns, grammar, facts, and contextual relationships within language. Large language models are based on transformer architecture, which use mechanisms such as self-attention to capture dependencies between words or phrases across long sequences of text. As a result, large language models can understand and generate content that maintains context and coherence over long passes, which make large language models versatile for a wide range of applications.

One of the major applications for large language models is data management. For example, large language models can be used to standardize or clean datasets by detecting inconsistencies, typos, or redundant information and automatically correcting those errors based on learned language patterns. In another example, large language models are highly effective at summarizing large volumes of text such as lengthy articles, legal documents, or research papers into concise summaries, making it easier to understand key points without manually processing the entire content.

### SUMMARY

According to one illustrative embodiment, a computer-implemented method for transforming data is provided. A processor set receives a number of data pairs. Each data pair in the number of data pairs comprises an input data and an output data that is semantically equivalent to the input data. The processor set creates a program graph for each data pair in the number of data pairs. Nodes in each program graph represent positions for characters from each data pair. The processor set identifies a number of paths between nodes in each program graph. Each path in the number of paths represents a sequence of characters in a data pair from the number of data pairs. The processor set identifies a number of common paths from the number of paths based on common characters between the input data and the output data for each data pair. The processor set identifies a set of nodes in the program graphs based on the number of common paths. The set of nodes represent positions of unmatched characters between input data and output data in the number of data pairs. The processor set generates a prompt for a large language model based on the number of data pairs and the set of nodes that represent positions of unmatched characters between input data and output data in the number of data pairs. According to other illustrative embodiments, a computer system, and a computer program product for transforming data are provided.

### BRIEF DESCRIPTION OF THE DRAWINGS

FIG. 1 is a pictorial representation of a computing environment in which illustrative embodiments may be implemented;

FIG. 2 is an illustration of a block diagram of a virtual spaces management environment in accordance with an illustrative embodiment;

FIG. 3 is an illustration of a process flow for managing virtual spaces in accordance with an illustrative embodiment;

FIG. 4 is a flowchart of a process for creating virtual spaces in accordance with an illustrative embodiment;

FIG. 5 is a flowchart of a process for identifying a speaker for the event in accordance with an illustrative embodiment;

FIG. 6 is a block diagram of a data processing system in accordance with an illustrative embodiment;

FIG. 7 is a flowchart of a process for outputting a new output data in accordance with an illustrative embodiment; and

FIG. 8 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one or more storage media (also called “mediums”) collectively included in a set of one or more storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

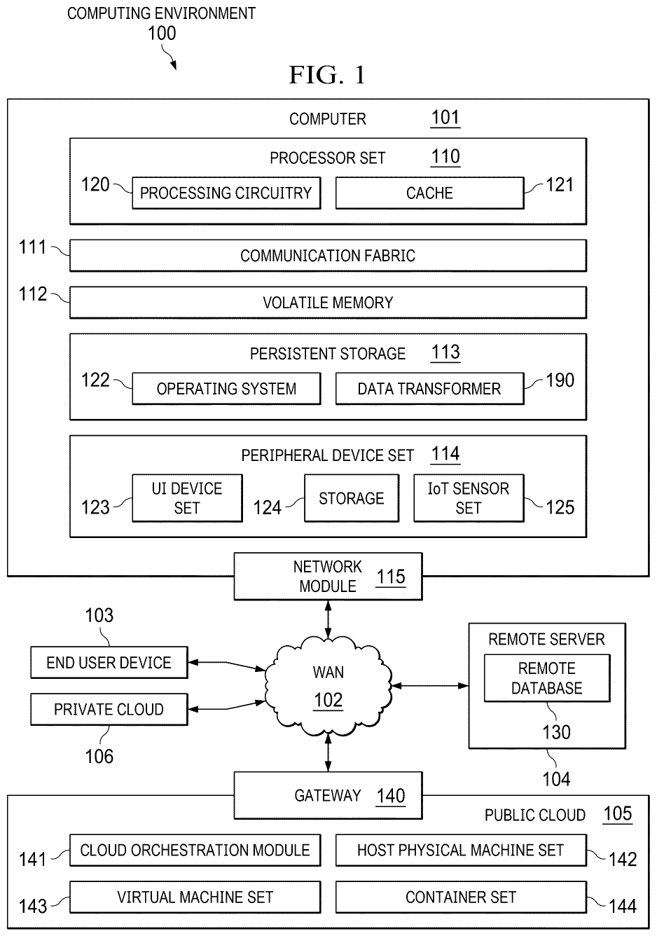

With reference now to the figures, and in particular with reference to FIG. 1, a block diagram of a computing environment is depicted in accordance with an illustrative embodiment. Computing environment 100 contains an example of an environment for the execution of at least some of the computer code involved in performing the inventive methods, such as data transformer 190. In addition to data transformer 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and data transformer 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one or more computer processors of any type now known or to be developed in the future. Processing circuitry 120 may be distributed over multiple packages, for example, multiple coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions and associated data are accessed by processor set 110 to control and direct performance of the inventive methods. In computing environment 100, at least some of the instructions for performing the inventive methods may be stored in data transformer 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in data transformer 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as a thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. For example, the illustrative embodiments recognize and take into account that inputs to the large language model are very crucial when used for real-world applications.

The illustrative embodiments also recognize and take into account that inputting too much information may confuse the large language model. In this case, an excessive amount of information to the large language model may not be appropriate to understand user intent. In addition, the large language model may be mystified by tasks specified by the user and generate inconsistent results with too much information.

The illustrative embodiments also recognize and take into account that a large language model requires a depth of understanding and experiences to solve complex, industry-specific challenges. The illustrative embodiments also recognize and take into account that updating a large language model's knowledge is complicated and requires training the mode, which is extremely expensive. In addition, instructing the large language model to override certain parts of its knowledge while retaining others is also challenging. Even then, there is no guarantee that the model will not provide outdated information.

Thus, illustrative embodiments of the present invention provide a computer implemented method, computer system, and computer program product for transforming data. A processor set receives a number of data pairs. Each data pair in the number of data pairs comprises an input data and an output data that is semantically equivalent to the input data. The processor set creates a program graph for each data pair in the number of data pairs. Nodes in each program graph represent positions for characters from each data pair. The processor set identifies a number of paths between nodes in each program graph. Each path in the number of paths represents a sequence of characters in a data pair from the number of data pairs. The processor set identifies a number of common paths from the number of paths based on common characters between the input data and the output data for each data pair. The processor set identifies a set of nodes in the program graphs based on the number of common paths. The set of nodes represent positions of unmatched characters between input data and output data in the number of data pairs. The processor set generates a prompt for a large language model based on the number of data pairs and the set of nodes that represent positions of unmatched characters between input data and output data in the number of data pairs.

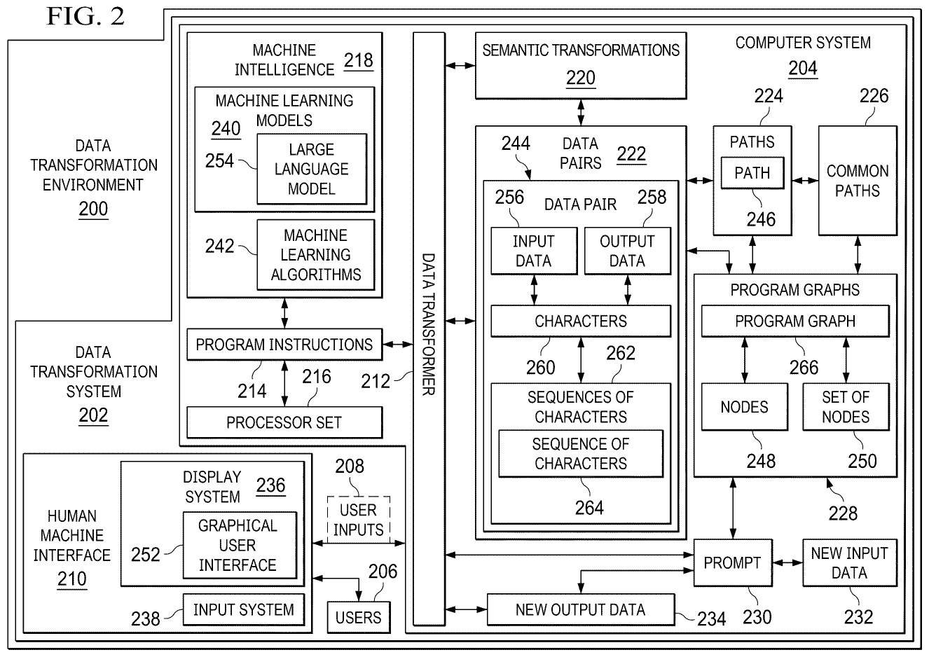

With reference now to FIG. 2, an illustration of a block diagram of a data transformation environment is depicted in accordance with an illustrative embodiment. In this illustrative example, data transformation environment 200 includes components that can be implemented in hardware such as the hardware shown in computing environment 100 in FIG. 1.

In this illustrative example, data transformation system 202 in data transformation environment 200 can be used to identify semantic relationships between input data and output data and use the semantic relationships to perform semantic transformations on new input data. In this illustrative example, data transformation system 202 includes computer system 204 which includes data transformer 212. Data transformer 212 is located in computer system 204. Data transformer 212 may be implemented using data transformer 190 in FIG. 1.

Data transformer 212 can be implemented in software, hardware, firmware, or a combination thereof. When software is used, the operations performed by data transformer 212 can be implemented in program instructions configured to run on hardware, such as a processor unit. When firmware is used, the operations performed by data transformer 212 can be implemented in program instructions and data can be stored in persistent memory to run on a processor unit. When hardware is employed, the hardware can include circuits that operate to perform the operations in data transformer 212.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C,” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes processor set 216 that is capable of executing program instructions 214 implementing processes in the illustrative examples. In other words, program instructions 214 are computer-readable program instructions.

As used herein, a processor unit in processor set 216 is a hardware device and is comprised of hardware circuits such as those on an integrated circuit that respond to and process instructions and program code that operate a computer. A processor unit can be implemented using processor set 110 in FIG. 1. When processor set 216 executes program instructions 214 for a process, processor set 216 can be one or more processor units that are in the same computer or in different computers. In other words, the process can be distributed between processor set 216 on the same or different computers in computer system 204.

Further, processor set 216 can be of the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

As depicted, computer system 204 includes machine intelligence 218. Machine intelligence 218 can include machine learning models 240 and machine learning algorithms 242. Machine learning models 240 is a branch of artificial intelligence (AI) that enables computers to detect patterns and improve performance without direct programming commands. Rather than relying on direct input commands to complete a task, machine learning models 240 relies on input data. The data is fed into the machine, one of machine learning algorithms 242 is selected, parameters for the data are configured, and the machine is instructed to find patterns in the input data through optimization algorithms. The data model formed from analyzing the data is then used to predict future values.

Machine intelligence 218 is continuously refined over time through trial and error. Equivalence of assets or products can be effectively performed by supervised machine learning so that products or assets that do not match descriptively can nevertheless be matched. Over time, the data model from machine learning can provide a greater degree of flexibility in matching machine intelligence 218.

Machine intelligence 218 can be implemented using one or more systems such as an artificial intelligence system, a neural network, a generative neural network, a Bayesian network, an expert system, a fuzzy logic system, a generic algorithm, or other suitable types of systems. Machine learning models 240 and machine learning algorithms 242 may make computer system 204 a special purpose computer for transforming input data into data that is semantically equivalent to the input data.

Machine learning models 240 involves using machine learning algorithms 242 to build computation models based on samples of data. The samples of data used for training are referred to as training data or training datasets. Machine intelligence 218 can make predictions without being explicitly programmed to make these predictions. Machine intelligence 218 can be used for training and retraining computation models for a number of different types of applications. These applications include, for example, medicine, financial services, healthcare, speech recognition, computer vision, or other types of applications.

In this illustrative example, machine learning models 240 can include a number of models. For example, machine learning models 240 can include a deep learning model such as large language model 254. In this illustrative example, large language model 254 is a type of machine learning model designed to understand, generate, and manipulate human language.

In this illustrative example, machine learning algorithms 242 can include supervised machine learning algorithms and unsupervised machine learning algorithms. Supervised machine learning can train machine learning models using data containing both the inputs and desired outputs. Examples of machine learning algorithms include XGBoost, K-means clustering, and random forest.

As depicted, data transformer 212 can receive data pairs 222 from a data source or user inputs. In this illustrative example, each data pair in data pairs 222 includes an input data and an output data that is semantically equivalent to the input data. For example, data pair 244 in data pairs 222 includes input data 256 and output data 258 that is semantically equivalent to input data 256. In this illustrative example, semantically equivalent data refers to expressions, statements, or representations having the same meaning even though they might differ in structure, wording or format.

For example, input data 256 can include “12-10-2020” and output data 258 can include “12/OCT/2020”. In this example, both input data 256 and output data 258 are directed to an expression of 12th day of October in year 2020, however, the structure and text included in input data 256 and output data 258 are different and cannot be converted easily.

As depicted, input data and output data in each data pair of data pairs 222 include characters. For example, input data 256 and output data 258 in data pair 244 include characters 260. In this illustrative example, data transformer 212 creates program graphs 228 for data pairs 222. Program graphs 228 are graphical representations for structures of input data and output data for data pairs 222. In this illustrative example, program graphs 228 include nodes 248 that represent positions for characters from each data pair in data pairs 222.

In this illustrative example, each program graph in program graphs 228 represents an input data or an output data from a data pair in data pairs 222. For example, data transformer 212 can create program graph 266 for data pair 244 based on characters 260 for input data 256 and output data 258.

In this illustrative example, data transformer 212 identifies a number of paths 224 between nodes in each program graph from program graphs 228. Each path in the number of paths 224 can represent a sequence of characters in a data pair from data pairs 222. In this illustrative example, paths can be identified for sequences of characters 262 based on characters 260 for input data 256 and output data 258 in data pair 244. In other words, each identified path represents a sequence of characters based on characters 260 for data pair 244. For example, path 246 can be created for sequence of characters 264 based on characters for output data 258 from characters 260 for program graph 266.

In this illustrative example, if output data 258 includes “12/OCT/2020”, sequence of characters 264 can be either “1”, “12”, “'12/”, “12/O”, “12/OC”, “12/OCT”, “12/OCT/”, “12/OCT/2”, “12/OCT/20”, “12/OCT/202”, or “12/OCT/2020”. Here, a path can be identified between nodes for characters mentioned above. For example, a path can be identified between node 0 and node 1 for sequence of characters “1”, a path can be identified between node 0 and node 2 for sequence of characters “12”, and a path can be identified between node 0 and node 3 for sequence of characters “12/”. It should be understood that paths 224 does not have to include the first node. For example, a path can be identified between node 1 and node 2 for sequence of characters “2” and a path can be identified between node 7 and node 11 for sequence of characters “2020”. In this illustrative example, each path in paths 224 can be generated using a number of different program instructions. In other words, each program instruction from the number of different program instructions corresponds to a sequence of characters for data pairs 222.

In this illustrative example, data transformer 212 identifies common paths 226 from the number of paths 224 based on common characters between input data and output data for each data pair in data pairs 222. In this illustrative example, common paths 226 are identified for all program graphs in program graphs 228.

In this illustrative example, data transformer 212 uses common paths 226 to identify characters that need to be semantically transformed between input data and output data in each data pair in data pairs 222. For example, input data 256 can include “12-10-2020” and output data 258 can include “12/OCT/2020”. In this example, common characters or matched characters between input data 256 and output data 258 are “12” and “2020”. On the other hand, the uncommon characters between input data 256 and output data 258 are “-10-” and “/OCT/”. In this case, transformation between syntax “-” and “/” can be easily achieved through a universal transformation rule. However, there is no transformation between “10” and “OCT” and cannot easily be achieved without knowing the semantic that they both represent the 10th month of the year. In other words, data transformer 212 can use common paths 226 to identify “10” and “OCT”, which are unmatched characters that need to be semantically transformed between input data 256 and output data 258.

In this illustrative example, data transformer 212 identifies set of nodes 250 in program graphs 228 based on common paths 226. In this illustrative example, set of nodes 250 represent positions of unmatched characters between input data and output data in data pairs 222.

In this illustrative example, data transformer 212 can identify the program instructions for generating a sequence of characters that include matched characters or common characters in data pairs 222. In this illustrative example, the identified program instructions can be ranked based on the accuracy of generating correct output data. In this illustrative example, data transformer 212 can select the top program instructions for generating a sequence of characters that includes matched characters or common characters in data pairs 222 based on the ranking.

In this illustrative example, data transformer 212 generates prompt 230 that can be used as input for large language model 254 in machine learning models 240 based on data pairs 222 and set of nodes 250 that represent positions of unmatched characters between input data and output data in data pairs 222. In this illustrative example, prompt 230 can include a table or an index that includes input data and output data for a data pair in data pairs 222 as well as positions of common characters and unmatched characters between input data and output data for a data pair in data pairs 222. In addition, the table can further include information associated with program instructions that generate common characters and unmatched characters between input data and output data for a data pair in data pairs 222.

For example, prompt 230 can include a table or an index that includes a row for data pair 244. In this case, the row in the index or table includes “12-10-2020” for input data 256, “12/OCT/2020” for output data 258, and “0-2” and “6-10” which indicate the positions of common characters or matched characters between input data 256 and output data 258. In other words, prompt 230 specifies parts of data that need to be semantically transformed between input data and output data for large language model 254 to identify the semantic relationship between unmatched characters between input data and output data in data pairs 222. In this illustrative example, data transformer 212 can identify semantic transformations 220 for data pairs 222. Semantic transformations 220 are data transformations that can be used to transform input data in data pairs 222 into output data in data pairs 222.

In this illustrative example, data transformer 212 can input new input data 232 with prompt 230 into large language model 254 for generating an output data. In this case, new input data 232 has same structures as input data in data pairs 222. Large language model 254 can perform semantic transformations 220 to new input data 232 to generate a new output data that includes semantically transformed characters based on semantic transformations 220.

In this illustrative example, users 206 can interact with computer system 204 via user inputs 208. User inputs 208 can be generated by users 206 using human machine interface (HMI) 210. As depicted, human machine interface 210 includes display system 236 and input system 238. Display system 236 is a physical hardware system and includes one or more display devices on which graphical user interface 252 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, virtual reality headsets, or some other suitable device that can output information for the visual presentation of information.

In this example, users 206 are people that can interact with graphical user interface 252 through user inputs 208 generated by input system 238. For example, user inputs 208 can include new input data 232 received from users 206. Input system 238 is a physical hardware system and can be selected from at least one of a mouse, a keyboard, a touch pad, a trackball, a touchscreen, a stylus, a motion sensing input device, a gesture detection device, a data glove, a cyber glove a haptic feedback device, or some other suitable type of input device. For example, users 206 can view program graphs 228, paths 224, data pairs 222, common paths 226, prompt 230, and new output data 234 through graphical user interface 252.

In one illustrative example, one or more solutions are present that overcome a problem with transforming data that are semantically equivalent to each other. As a result, one or more technical solutions may provide an ability to increase the efficiency for transforming data for computer system 204. In this illustrative example, transforming semantically equivalent data is challenging due to a number of factors. For example, transformation of semantically equivalent data is difficult due to the inherent ambiguity and context sensitivity of data. Different pieces of data may be equivalent in meaning, but how they should be transformed or standardized often depends on the specific context. In other words, a manual transformation of semantically equivalent data requires users to possess large amount of knowledges associated with different variations of semantically equivalent data.

In addition, manual transformation of data is difficult when dealing with large amount of data, especially when data are formatted in complex data structure such as hierarchical or nested data. In this illustrative example, manual transformation of data is limited by human's capacity to recognize and apply patterns consistently across different datasets.

Therefore, the illustrative embodiments provide methods for identifying patterns in data entries in a large dataset in a quick, efficient manner and transform data into semantically equivalent data without requiring users to possess the knowledge of different variations of data that are semantically equivalent to each other. In this illustrative example, the efficiency and accuracy of data transformations provided by the illustrative embodiments can contribute to an improvement in computer functioning because computer resources can be efficiently allocated and used for transforming data as well as performing other tasks at the same time.

In the illustrative example, computer system 204 can be configured to perform at least one of the steps, operations, or actions described in the different illustrative examples using software, hardware, firmware, or a combination thereof. As a result, computer system 204 operates as a special purpose computer system in which data transformer 212 in computer system 204 enables automating data transformation between data that are semantically equivalent to each other. In particular, data transformer 212 transforms computer system 204 into a special purpose computer system as compared to currently available general computer systems that do not have a data transformer 212.

In the illustrative example, the use of data transformer 212 in computer system 204 integrates processes into a practical application for automating data transformation between data that are semantically equivalent to each other without manually specifying the semantic relationships between data.

The illustration of data transformation environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

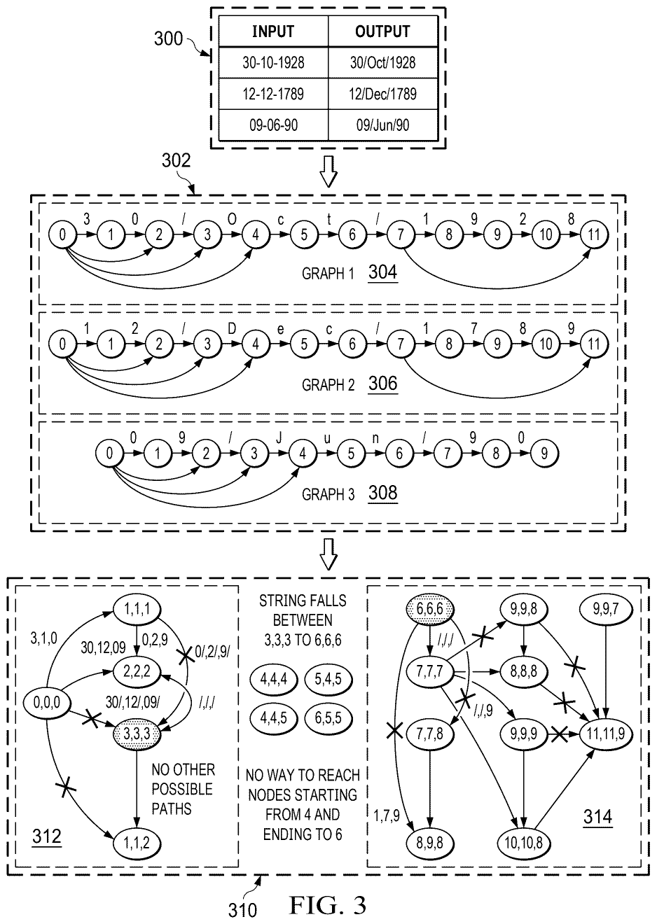

With reference now to FIG. 3, an illustration of a process flow for identifying positions of uncommon characters in data pairs is shown in accordance with an illustrative embodiment. The process flow in FIG. 3 can be implemented in hardware, software, or both. When implemented in software, the process flow can take the form of program instructions that are run by one of more processor units located in one or more hardware devices in one or more computer systems. For example, the process can be implemented in data transformer 212 in computer system 204 in FIG. 2.

In FIG. 3, table 300 includes data pairs with input data and output data that is semantically equivalent to the input data. In this illustrative example, data pairs in table 300 can be examples of data pairs 222 in FIG. 2. Input data in the first column of table 300 can be examples of input data 256 in FIG. 2 and output data in the second column of table 300 can be examples of output data 258 in FIG. 2.

In this illustrative example, output data in table 300 are used for generating program graphs 302. Each output data is used for generating one program graph in program graphs 302. For example, output of “30/Oct/1928” can be used for generating program graph 304, output of “12/Dec/1789” can be used for generating program graph 306, and output of “09/Jun/90” can be used for generating program graph 308.

As depicted, each node in program graphs 302 represents a position for a character in an output data from table 300. For example, nodes 0 in program graph 304, program graph 306, and program graph 308 represent positions of the first characters “3”, “1”, and “0” in output data from table 300. In a similar fashion, nodes 4 in program graph 304, program graph 306, and program graph 308 represent positions of the fifth characters “c”, “e”, and “u” in output data from table 300. In yet another example, nodes 9 in program graph 304, program graph 306, and program graph 308 represent positions of the first characters “9”, “7”, and “0” in output data from table 300.

A number of paths are created between nodes in each program graph of program graphs 302. In FIG. 3, each arrow between two nodes in a program graph of program graphs 302 represents a path from the number of paths. As depicted, each path created between nodes in program graphs 302 represents a sequence of characters in program graphs 302. For example, the path between node 0 and node 1 for program graph 304 represents “3” and the path between node 7 and node 11 for program graph 304 represent “1928”. It should be understood that not all paths are shown on program graphs 302 for visualization purposes. In other words, the paths shown on program graphs 302 do not include all possible paths that can be created for program graphs 302.

In FIG. 3, illustration 310 shows a process for identifying positions of uncommon characters between input data and output data in table 300 using common paths for program graphs 302. In this illustrative example, common paths are paths between a set of nodes in program graphs 302 to another set of nodes in program graphs 302 based on common characters or matched characters between input data and output data in table 300. For example, graph 312 shows common paths that originated from nodes 0 of all program graphs (0,0,0) in program graphs 302 to nodes 1, nodes 2, and nodes 3 of all program graphs (1,1,1, 2,2,2, and 3,3,3) in program graphs 302. In addition, graph 312 also shows common paths that originated from nodes 0 of all program graphs (0,0,0) in program graphs 302 to node 1 of program graph 304, node 1 of program graph 306, and node 2 of program graph 308 (1,1,2). In this illustrative example, node 0 of all program graphs in program graphs 302 can be referred as source nodes.

In a similar fashion, graph 314 shows common paths that originated from nodes 0 of all program graphs (6,6,6) in program graphs 302 to nodes 7, nodes 8, and nodes 9 of all program graphs (7,7,7, 8,8,8, and 9,9,9) in program graphs 302. In addition, graph 312 also shows other common paths such as the common path that originated from nodes 6 of all program graphs (6,6,6) in program graphs 302 to node 7 of program graph 304, node 7 of program graph 306, and node 8 of program graph 308 (7,7,8). In this illustrative example, node 11 in program graph 304, node 11 in program graph 306, and node 9 in program graph 308 can be referred to as target node. In other words, target nodes in program graph 304, program graph 306, and program graph 308 represent the last characters in program graphs.

In this illustrative example, the common paths created for program graphs 302 indicate positions of uncommon characters between input data and output data in table 300. However, it should be understood that syntax such as “-” and “/” are considered as matched characters/common characters since those syntaxes can be easily converted between each other. However, common paths cannot include nodes for “Oct” in program graph 304, “Dec” in program graph 306, and “Jun” in program graph 308 because those characters cannot be easily converted from “10”, “12”, and “06” without knowing that they are semantically equivalent.

In this illustrative example, max depth descendants from source nodes are identified. In this illustrative example, the max depth descendants from source nodes are the furthest descendant that are either directly or indirectly connected to source nodes through common paths.

For example, in graph 312, possible descendants from source nodes “0,0,0” are “1,1,1”, “2,2,2”, and “3,3,3”. In graph 312, common paths that have no contribution to the determination of the max depth descendants are crossed. In this illustrative example, the max depth descendants from source nodes are “3,3,3” because common paths for reaching descendant “3,3,3” are longest. In other words, nodes 3 of all program graphs are the max depth descendants from source nodes 0.

In a similar fashion, max depth ancestors from targe nodes are identified. In this illustrative example, the max depth ancestors from target nodes are the furthest ancestors that are either directly or indirectly connected to target nodes through common paths.

For example, in graph 314, possible descendants from target nodes “11,11,9” are “9,9,7”, “10,10,8”, “7,7,7”, and “6,6,6”. In graph 314, common paths that have no contribution to the determination of the max depth ancestors are crossed. In this illustrative example, the max depth ancestors from target nodes are “6,6,6” because common paths for reaching ancestors “6,6,6” are longest. In other words, nodes 6 of all program graphs are the max depth ancestors from target nodes in program graphs 302.

In this illustrative example, the max depth descendants of “3,3,3” and the max depth ancestors of “6,6,6” can be used for identifying positions of uncommon characters between input data and output data in table 300.

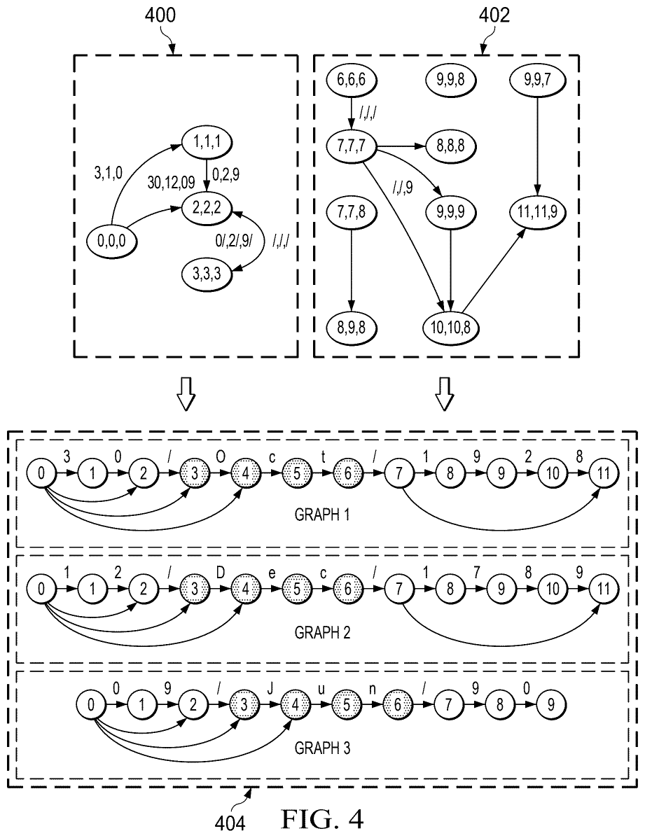

With reference now to FIG. 4, an illustration of a process flow for identifying positions of uncommon characters in data pairs is shown in accordance with an illustrative embodiment. In FIG. 4, graph 400 is a cleaned version of graph 312 in FIG. 3 and graph 402 is a cleaned version of graph 314 in FIG. 3. As depicted, the max depth descendants of “3,3,3” and the max depth ancestors of “6,6,6” are identified.

In this illustrative example, the max depth descendants of “3,3,3” and the max depth ancestors of “6,6,6” indicate that there is no way to reach nodes starting from node 4 and ending at node 6 in any program graph. In other words, positions for uncommon characters between input data and output data from table 300 falls between the max depth descendants of “3,3,3” and the max depth ancestors of “6,6,6”.

As a result, positions of uncommon characters between input data and output data are identified based on the method described above. In this illustrative example, uncommon characters between input data and output data are highlighted in program graph 404.

As depicted, information associated with uncommon characters between input data and output data can be used for constructing prompts for a large language model to identify semantic relationships between uncommon characters between input data and output data. For example, the large language model can easily relate “10”, “12”, and “06” to “Oct”, “Dec” and “Jun” as the months of year once information associated with those characters have been identified and provided to the large language model. As a result, the prompts can be used with new input data to generate new output data that is semantically equivalent to the new input data.

The illustration of process flow in FIGS. 3-4 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. The method described above can also be used to transform other types of semantically equivalent data that are not associated with date.

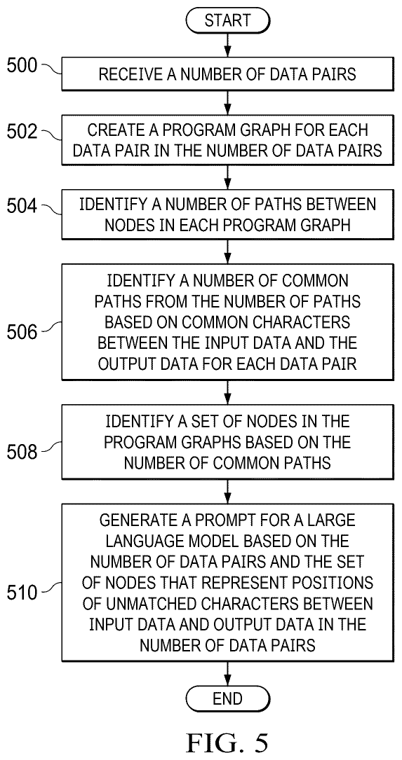

With reference now to FIG. 5, a flowchart illustrating a process for transforming data is shown in accordance with an illustrative embodiment. The process in FIG. 5 can be implemented in hardware, software, or both. When implemented in software, the process can take the form of program instructions that are run by one of more processor units located in one or more hardware devices in one or more computer systems. For example, the process can be implemented in data transformer 212 in computer system 204 in FIG. 2.

The process begins by receiving a number of data pairs (step 500). In this step, each data pair in the number of data pairs comprises an input data and an output data that is semantically equivalent to the input data. The process creates a program graph for each data pair in the number of data pairs (step 502). In step 502, nodes in each program graph represent positions for characters from each data pair.

The process identifies a number of paths between nodes in each program graph (step 504). In step 504, each path in the number of paths represents a sequence of characters in a data pair from the number of data pairs. The process identifies a number of common paths from the number of paths based on common characters between the input data and the output data for each data pair (step 506).

The process identifies a set of nodes in the program graphs based on the number of common paths (step 508). In step 508, the set of nodes represent positions of unmatched characters between input data and output data in the number of data pairs. The process generates a prompt for a large language model based on the number of data pairs and the set of nodes that represent positions of unmatched characters between input data and output data in the number of data pairs (step 510). The process terminates thereafter.

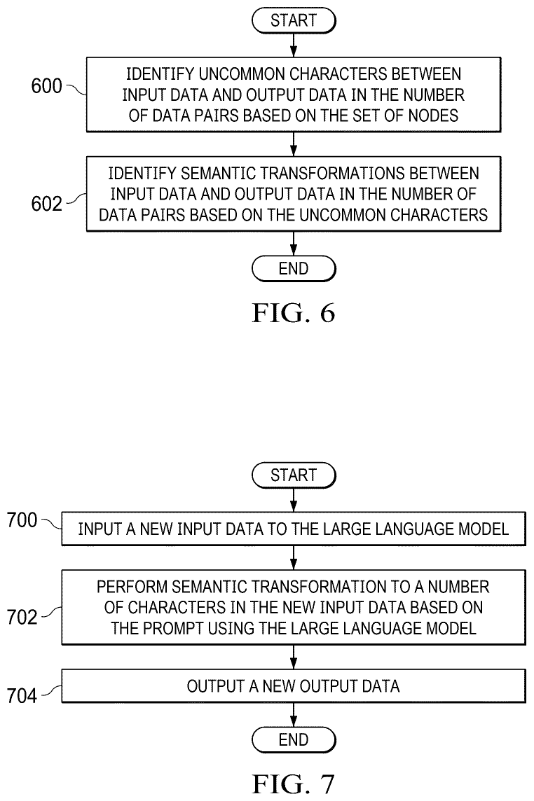

Turning next to FIG. 6, a flowchart of a process for identifying semantic transformations is depicted in accordance with an illustrative embodiment. The process in this figure is an example of an additional step that can be performed with the steps in FIG. 5.

The process begins by identifying uncommon characters between input data and output data in the number of data pairs based on the set of nodes (step 600). The process identifies semantic transformations between input data and output data in the number of data pairs based on the uncommon characters (step 602). The process terminates thereafter.

Turning next to FIG. 7, a flowchart of a process for outputting a new output data is depicted in accordance with an illustrative embodiment. The process in this figure is an example of an additional step that can be performed with the steps in FIG. 5.

The process begins by inputting a new input data to the large language model (step 700). The process performs semantic transformation to a number of characters in the new input data based on the prompt using the large language model (step 702). The process outputs a new output data (step 704). In this step, the new output data comprises semantically transformed characters using the large language model. The process terminates thereafter.

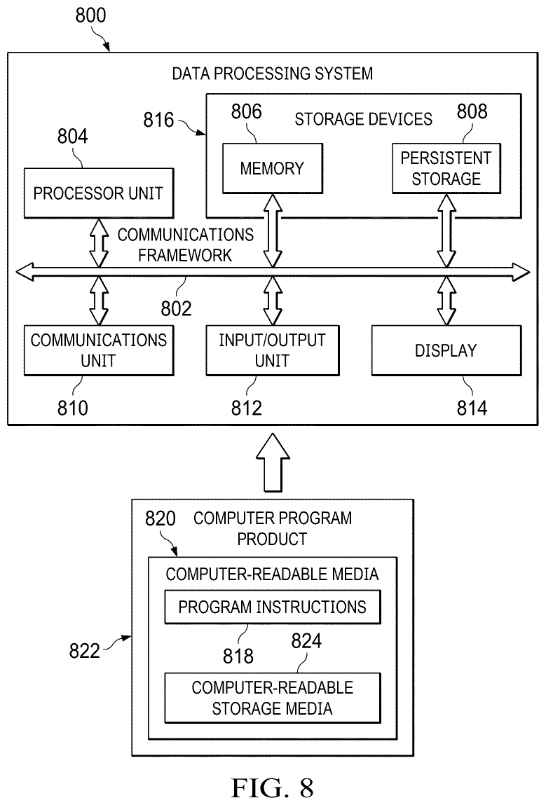

Turning now to FIG. 8, a block diagram of a data processing system is depicted in accordance with an illustrative embodiment. Data processing system 800 can be used to implement computers and computing devices in computing environment 100 in FIG. 1. Data processing system 800 can also be used to implement computer system 204 in FIG. 2. In this illustrative example, data processing system 800 includes communications framework 802, which provides communications between processor unit 804, memory 806, persistent storage 808, communications unit 810, input/output (I/O) unit 812, and display 814. In this example, communications framework 802 takes the form of a bus system.

Processor unit 804 serves to execute instructions for software that can be loaded into memory 806. Processor unit 804 includes one or more processors. For example, processor unit 804 can be selected from at least one of a multicore processor, a central processing unit (CPU), a graphics processing unit (GPU), a physics processing unit (PPU), a digital signal processor (DSP), a network processor, or some other suitable type of processor. Further, processor unit 804 can be implemented using one or more heterogeneous processor systems in which a main processor is present with secondary processors on a single chip. As another illustrative example, processor unit 804 can be a symmetric multi-processor system containing multiple processors of the same type on a single chip.

Memory 806 and persistent storage 808 are examples of storage devices 816. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 816 may also be referred to as computer-readable storage devices in these illustrative examples. Memory 806, in these examples, can be, for example, a random-access memory or any other suitable volatile or non-volatile storage device. Persistent storage 808 may take various forms, depending on the particular implementation.

For example, persistent storage 808 may contain one or more components or devices. For example, persistent storage 808 can be a hard drive, a solid-state drive (SSD), a flash memory, a rewritable optical disk, a rewritable magnetic tape, or some combination of the above. The media used by persistent storage 808 also can be removable. For example, a removable hard drive can be used for persistent storage 808.

Communications unit 810, in these illustrative examples, provides for communications with other data processing systems or devices. In these illustrative examples, communications unit 810 is a network interface card.

Input/output unit 812 allows for input and output of data with other devices that can be connected to data processing system 800. For example, input/output unit 812 may provide a connection for user input through at least one of a keyboard, a mouse, or some other suitable input device. Further, input/output unit 812 may send output to a printer. Display 814 provides a mechanism to display information to a user.

Instructions for at least one of the operating system, applications, or programs can be located in storage devices 816, which are in communication with processor unit 804 through communications framework 802. The processes of the different embodiments can be performed by processor unit 804 using computer-implemented instructions, which may be located in a memory, such as memory 806.

These instructions are referred to as program instructions, computer usable program instructions, or computer-readable program instructions that can be read and executed by a processor in processor unit 804. The program instructions in the different embodiments can be embodied on different physical or computer-readable storage media, such as memory 806 or persistent storage 808.

Program instructions 818 are located in a functional form on computer-readable media 820 that is selectively removable and can be loaded onto or transferred to data processing system 800 for execution by processor unit 804. Program instructions 818 and computer-readable media 820 form computer program product 822 in these illustrative examples. In the illustrative example, computer-readable media 820 is computer-readable storage media 824.

Computer-readable storage media 824 is a physical or tangible storage device used to store program instructions 818 rather than a medium that propagates or transmits program instructions 818. Computer-readable storage media 824, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 818 can be transferred to data processing system 800 using a computer-readable signal media. The computer-readable signal media are signals and can be, for example, a propagated data signal containing program instructions 818. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 820” can be singular or plural. For example, program instructions 818 can be located in computer-readable media 820 in the form of a single storage device or system. In another example, program instructions 818 can be located in computer-readable media 820 that is distributed in multiple data processing systems. In other words, some instructions in program instructions 818 can be located in one data processing system while other instructions in program instructions 818 can be located in one data processing system. For example, a portion of program instructions 818 can be located in computer-readable media 820 in a server computer while another portion of program instructions 818 can be located in computer-readable media 820 located in a set of client computers.

The different components illustrated for data processing system 800 are not meant to provide architectural limitations to the manner in which different embodiments can be implemented. In some illustrative examples, one or more of the components may be incorporated in or otherwise form a portion of another component. For example, memory 806, or portions thereof, may be incorporated in processor unit 804 in some illustrative examples. The different illustrative embodiments can be implemented in a data processing system including components in addition to or in place of those illustrated for data processing system 800. Other components shown in FIG. 8 can be varied from the illustrative examples shown. The different embodiments can be implemented using any hardware device or system capable of running program instructions 818.

Thus, illustrative embodiments of the present disclosure provide a computer-implemented method, computer system, and computer program product for managing containers. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for transforming data, the computer implemented method comprising:
receiving, by a processor set, a number of data pairs, wherein each data pair in the number of data pairs comprises an input data and an output data that is semantically equivalent to the input data;
creating, by the processor set, a program graph for each data pair in the number of data pairs, wherein nodes in each program graph represent positions for characters from each data pair;
identifying, by the processor set, a number of paths between nodes in each program graph, wherein each path in the number of paths represents a sequence of characters in a data pair from the number of data pairs;
identifying, by the processor set, a number of common paths from the number of paths based on common characters between the input data and the output data for each data pair;
identifying, by the processor set, a set of nodes in the program graphs based on the number of common paths, wherein the set of nodes represent positions of unmatched characters between input data and output data in the number of data pairs; and
generating, by the processor set, a prompt for a large language model based on the number of data pairs and the set of nodes that represent positions of unmatched characters between input data and output data in the number of data pairs.

2. The computer implemented method of claim 1, further comprising:
identifying, by the processor set, uncommon characters between input data and output data in the number of data pairs based on the set of nodes; and
identifying, by the processor set, semantic transformations between input data and output data in the number of data pairs based on the uncommon characters.

3. The computer implemented method of claim 1, wherein the set of nodes are identified based on possible paths between a number of source nodes in the program graph and a number of target nodes in the program graph, wherein the number of source nodes represent positions for first characters in the output data from the number of data pairs and the number of target nodes represent positions for last characters in the output data from the number of data pairs.

4. The computer implemented method of claim 1, wherein each path in the number of paths is identified by matching common characters between the input data and the output data in each data pair from the number of data pairs.

5. The computer implemented method of claim 1, further comprising:
inputting, by the processor set, a new input data to the large language model;
performing, by the processor set using the large language model, semantic transformation to a number of characters in the new input data based on the prompt; and
outputting, by the processor set using the large language model, a new output data, wherein the new output data comprises semantically transformed characters.

6. The computer implemented method of claim 1, wherein each path from the number of paths is identified by a different program instruction.

7. The computer implemented method of claim 1, wherein the prompt comprises an index constructed based on the number of data pairs and position of matched characters between input data and output data in the number of data pairs.

8. A computer system for transforming data, comprising:
a processor set;
a set of one or more computer-readable storage media; and
program instructions stored on the set of one or more storage media to cause the processor set to perform operations comprising:
receiving a number of data pairs, wherein each data pair in the number of data pairs comprises an input data and an output data that is semantically equivalent to the input data;
creating a program graph for each data pair in the number of data pairs, wherein nodes in each program graph represent positions for characters from each data pair;
identifying a number of paths between nodes in each program graph, wherein each path in the number of paths represents a sequence of characters in a data pair from the number of data pairs;
identifying a number of common paths from the number of paths based on common characters between the input data and the output data for each data pair;
identifying a set of nodes in the program graphs based on the number of common paths, wherein the set of nodes represent positions of unmatched characters between input data and output data in the number of data pairs; and
generating a prompt for a large language model based on the number of data pairs and the set of nodes that represent positions of unmatched characters between input data and output data in the number of data pairs.

9. The computer system of claim 8, wherein the operations further comprise:
identifying uncommon characters between input data and output data in the number of data pairs based on the set of nodes; and
identifying semantic transformations between input data and output data in the number of data pairs based on the uncommon characters.

10. The computer system of claim 8, wherein the set of nodes are identified based on possible paths between a number of source nodes in the program graph and a number of target nodes in the program graph, wherein the number of source nodes represent positions for first characters in the output data from the number of data pairs and the number of target nodes represent positions for last characters in the output data from the number of data pairs.

11. The computer system of claim 8, wherein each path in the number of paths is identified by matching common characters between the input data and the output data in each data pair from the number of data pairs.

12. The computer system of claim 8, wherein the operations further comprise:
inputting a new input data to the large language model;
performing semantic transformation to a number of characters in the new input data based on the prompt using the large language model; and
outputting a new output data, wherein the new output data comprises semantically transformed characters using the large language model.

13. The computer system of claim 8, wherein each path from the number of paths is identified by a different program instruction.

14. The computer system of claim 8, wherein the prompt comprises an index constructed based on the number of data pairs and position of matched characters between input data and output data in the number of data pairs.

15. A computer program product for transforming data, comprising:
a set of one or more computer-readable storage media;
program instructions stored in the set of one or more storage media to perform operations comprising:
receiving, by a processor set, a number of data pairs, wherein each data pair in the number of data pairs comprises an input data and an output data that is semantically equivalent to the input data;
creating, by the processor set, a program graph for each data pair in the number of data pairs, wherein nodes in each program graph represent positions for characters from each data pair;
identifying, by the processor set, a number of paths between nodes in each program graph, wherein each path in the number of paths represents a sequence of characters in a data pair from the number of data pairs;
identifying, by the processor set, a number of common paths from the number of paths based on common characters between the input data and the output data for each data pair;
identifying, by the processor set, a set of nodes in the program graphs based on the number of common paths, wherein the set of nodes represent positions of unmatched characters between input data and output data in the number of data pairs; and
generating, by the processor set, a prompt for a large language model based on the number of data pairs and the set of nodes that represent positions of unmatched characters between input data and output data in the number of data pairs.

16. The computer program product of claim 15, wherein the operations further comprise:
identifying, by the processor set, uncommon characters between input data and output data in the number of data pairs based on the set of nodes; and
identifying, by the processor set, semantic transformations between input data and output data in the number of data pairs based on the uncommon characters.

17. The computer program product of claim 15, wherein the set of nodes are identified based on possible paths between a number of source nodes in the program graph and a number of target nodes in the program graph, wherein the number of source nodes represent positions for first characters in the output data from the number of data pairs and the number of target nodes represent positions for last characters in the output data from the number of data pairs.

18. The computer program product of claim 15, wherein each path in the number of paths is identified by matching common characters between the input data and the output data in each data pair from the number of data pairs.

19. The computer program product of claim 15, wherein the operations further comprise:
inputting, by the processor set, a new input data to the large language model;
performing, by the processor set using the large language model, semantic transformation to a number of characters in the new input data based on the prompt; and
outputting, by the processor set using the large language model, a new output data, wherein the new output data comprises semantically transformed characters.

20. The computer program product of claim 15, wherein each path from the number of paths is identified by a different program instruction.
